(19) United States
(12) Patent Application Publication
(10) Pub. No.: US 2005/0052018 A1
(43) Pub. Date: Mar. 10, 2005

(54) Apparatus for coupling dryer to vent ducting and method of use

(76) Inventor: Michael R. Pichotta, The Woodlands, TX (US)

Correspondence Address: THE MATTHEWS FIRM, 2000 BERING DRIVE, SUITE 700, HOUSTON, TX, 77057, US

(21) Appl. No.: 10/840,970

(22) Filed: May 7, 2004

Related U.S. Application Data
(63) Continuation-in-part of application No. 10/162,013, filed on Jun. 4, 2002, now abandoned.
Application No. 10/162,013 is a continuation-in-part of application No. 09/602,997, filed on Jun. 23, 2000, now abandoned.

(51) Int. Cl. F16L 25/00

(52) U.S. Cl. 285/9.1

(57) ABSTRACT

This apparatus and method simplifies the installation of a dryer unit to the vent ducting, and facilitates the installation and disconnection of the dryer by couplings that are self connecting and are removably and releasably attachable to one other. This invention allows the connection of a dryer exhaust pipe to vent ducting such that a unit may be positioned in close proximity to a wall whereby the exhaust of the unit may flow from the exhaust pipe, across the apparatus, to the venting system. The apparatus of this invention can also be used with additional tubing or couplings, if necessary.

### RELATED APPLICATIONS

This is a Continuation in Part of U.S. application Ser. No. 10/162,013 filed on Jun. 4, 2002, which is pending, which was a continuation in part of U.S. application Ser. No. 09/602,997, filed on 23 Jun. 2000, which is abandoned.

### BRIEF DESCRIPTION OF DRAWINGS

To understand the nature and objects of the present invention, reference should be had to the following detailed description, taken in conjunction with the accompanying drawings, wherein:

FIG. 1 is an illustration of an embodiment of the present invention attached to the exhaust pipe of a dryer and vent ducting in a building with the flexible flue in a collapsed position;

FIG. 1a is a larger illustration of an embodiment of the present invention attached to the exhaust pipe of a dryer and vent ducting in a building with the couplings in an attached position with the flexible flue in an extended position;

FIG. 2 is an illustration of an additional embodiment of the present invention attached to the exhaust pipe of a dryer and vent ducting in a building with the couplings in an attached position with the flexible flue in a collapsed position;

FIG. 2a is a larger illustration of an additional embodiment of the present invention to the exhaust pipe of a dryer and vent ducting in a building with the couplings in an attached position with the flexible flue in a extended position;

FIG. 3 is a larger illustration of the embodiment in FIG. 1a, with the connector plate and receiver plate aligned, but unjoined, and with the receiver coupling anchored to a structure with the connector coupling attached to an exhaust pipe;

FIG. 4 is a larger illustration of the couplings of the embodiment in FIG. 2a with the connector plate and receiver plate aligned and joined, with the receiver coupling plate secured to a structure and the flue of the connector coupling attached to a dryer exhaust pipe;

FIG. 5 and FIG. 5a are illustrations of a pair of plates viewed from their inner faces with FIG. 5 being an illustration of an embodiment of a connector coupling of the present invention viewed from the inside face of a quadrangular connector plate; and FIG. 5a being an illustration of an embodiment of a receiver coupling of the present invention viewed from the inside face of a quadrangular receiver plate;

FIG. 5b is the outer face of a receiver or connector plate that is quadrangular;

FIG. 6 and FIG. 6a are illustrations of a pair of plates viewed from their inner faces with FIG. 6 being an illustration of an embodiment of a connector coupling of the present invention viewed from the inside face of the coupling with a circular connector plate, with FIG. 6a being an illustration of an embodiment of a receiver coupling of the present invention viewed from the inside face of a circular receiver plate;

FIG. 6b and FIG. 6c are illustrations of a pair of plates viewed from their inner faces with FIG. 6b being an illustration of an embodiment of a connector coupling of the present invention viewed from the inside face of a circular connector plate, and FIG. 6c being an illustration of an embodiment of a receiver coupling of the present invention viewed from the inside face of a quadrangular receiver plate;

FIG. 7 is a side view illustration of an embodiment of the present invention, connected to a dryer exhaust pipe and vent ducting that are vertically distanced, with the couplings being aligned, but unjoined, with the flexible flue in an extended position and the receiver coupling secured to a structure and having the second flue in an angled position;

FIG. 8 is a side view illustration of an embodiment of the present invention of a connector coupling having a flue with an external spring, with the faces of the receiver and connector plates in an aligned, and attached position;

FIG. 9 is aside view illustration of an embodiment of a connector coupling having a flue with an external spring, without magnets, and with hook and loop fasteners attachment means with the inner faces of the receiver and connector plates being in an aligned, but unjoined state;

FIG. 10 is a close-up side view of an embodiment of this invention showing the flue of a receiver plate inserted into an angular coupling attached to vent ducting in a wall;

FIG. 11a is an illustration of the outer face of a receiver coupling or connector coupling;

FIG. 11b is an illustration of the back view of the outer face of the receiver plate of the invention with an angular flue;

FIG. 11c is a further illustration of an outlet view of an angular or angled flue in a receiver plate of a coupling of the present invention;

FIG. 12 is a cross section view of a connection between a flue and a receiver or connector plate;

FIG. 13 is a cross section view of a flue showing an alternative connection of the flue connected to a connector plate; and

FIG. 14 is a cross section view of an alternative embodiment showing the connection between a flue and a connector plate wherein the flue is molded into the connector plate.

### DETAILED DESCRIPTION AND PREFERRED MODE FOR CARRYING OUT THE INVENTION

There are various prior art ways to connect the exhaust piping of a clothes dryer to vent ducting so that the heated and humid exhaust can be channeled away from the dryer, and to the outdoors, if desired. Applicant has invented a novel way of releasably connecting a dryer exhaust pipe to vent ducting that may be installed in a structure, such as a building. Of course, the vent ducting need not be inside a wall, but may instead be placed on the wall surface and run to an exit to the outside.

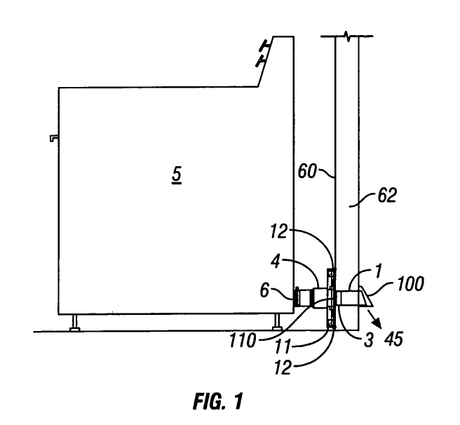

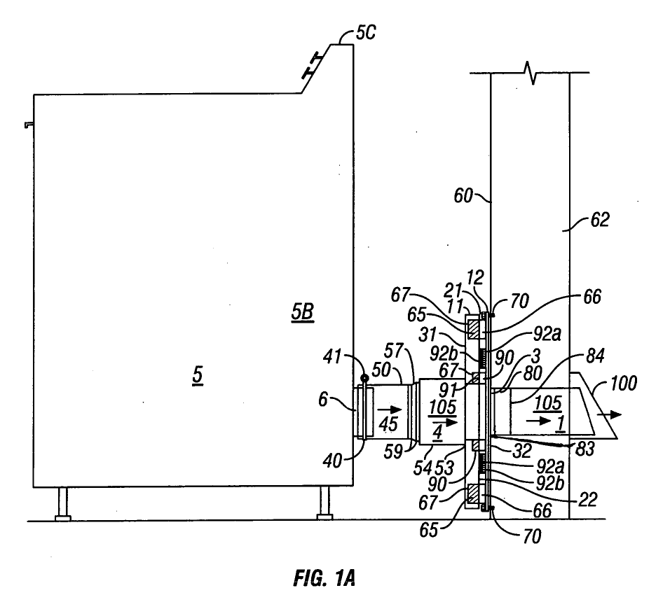

Referring now to FIGS. 1-10, most of the common elements of the various embodiments will be described. In this invention, there is a connector coupling 4 and a receiver coupling 3 that are capable of releasable attachable to one another. Coupling 4 is comprised of a connector plate 11, that has an inner face 21, an outer face 31, and a first aperture 15 that extends through the inner face 21 and the outer face 31 of the connector plate 11. The coupling is also comprised of a first flue 50 that has an inlet end 52 and an outlet end 54. If the connector coupling is attached to a dryer, the inlet end is sized for mating connection with the exhaust pipe 6 of a unit that produces an exhaust, such as a dryer 5. The outlet end 54 of the first flue 50 is connected to the plate inside the aperture, or alternatively, edgewisely 53, of the edge of the aperture, or near the first aperture 15. The outlet end of the flue extends inwardly toward the outer face 31 and/or inner face 21 of the connector plate. The inner face 21 of connector plate 11 of the connector coupling 4 is capable of releasable attachment to the inner face 22 of the receiver plate 12 of the receiver coupling 3.

The receiver coupling 3 is made of a receiver plate 12 that has an inner face 22 and an outer face 32. A second aperture 16 that extends through the inner face 22 and the outer face 32 of the receiver plate 12. When the first 15 and second apertures 16 are aligned, a throughpassage 110 is formed. The receiver coupling has a second flue 80 that has an inlet end 82 and an outlet end 84, with the inlet end being connected to the receiver plate. During use, if the receiver plate is attached to a structure the outlet end is sized for mating connection to vent ducting 1, e.g., within the wall cavity 62. The outlet end of the flue extends outwardly, or away, from the inner face 22 and/or outer face 32 of the receiver plate 12. The inlet end 82 of the flue is connected to the receiver plate inside the aperture, or alternatively, edgewisely 83, or at or near the second aperture 16.

There are various types of attachment members that can be installed into or onto the inner face surfaces 21, 22 of the connector and receiver plates, 11, 12, such as magnets 65 and/or at least one set of hook and loop fasteners 92a, 92b, and the like that allow releasable attachment of the inner surfaces or faces of the plates 21, 22 or of the attachment members that are installed into or onto the inner surface of the plates. Additionally, there may be a gasket 90 that extends around the aperture of a plate to form a seal 91 and prevent the escape of exhaust. When the apertures of the receiver and connector plate are in substantial alignment and when the inner faces are releasably attached to one another, there is a throughpassage 110 between the couplings 3, 4 that in conjunction with the flues provides a path for the flow 105 of exhaust 45 from the dryer exhaust pipe 6 through the couplings and out the vent ducting 1.

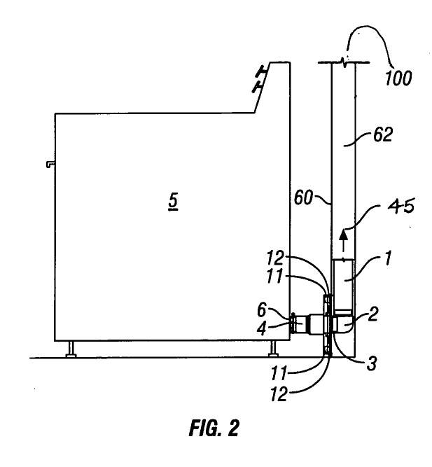

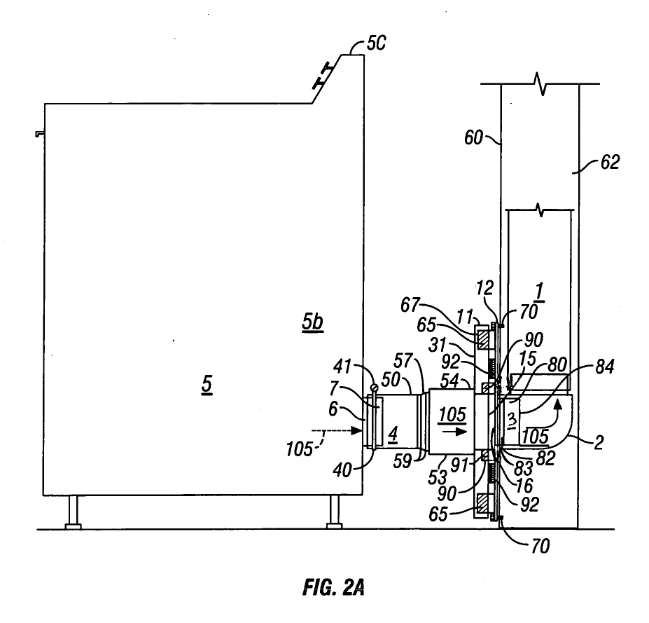

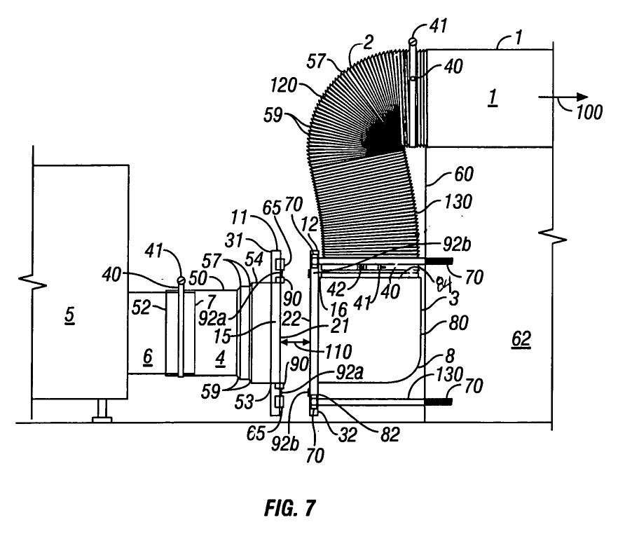

FIGS. 1 and 1a, an embodiment of the invention shows an attachment connector coupling 4 with a connector plate 11 and a first flue 50 that is attached to the exhaust pipe 6 of a dryer 5 with the inner face 21 of connector plate 11 4 releasably attached to the inner face 22 of the receiver plate 12 of a receiver coupling 3 that has a second flue 80 which is further connected to vent ducting 1, e.g., within the wall cavity 62. While the present invention can function without a flexible conduit which is typically used to connect a dryer exhaust pipe 6 to the ducting system, conduit may still be needed to compensate for the distance between the dryer exhaust pipe 6 and vent ducting 1 if the exhaust pipe and vent ducting are vertically or horizontally unaligned, as shown in FIG. 7. Further, during use of this invention, dryer 5 and wall 60 or structure may be separated by a distance of a few inches, such as 1-5 inches or more, or be used between the dryer 5 and a wall 60, located in close proximity to one another, of 1 inch or less, if necessary or desired. The exhaust can also be directed upward through vent ducting inside or outside the wall cavity 62, as disclosed in FIG. 2 or FIG. 7, the ceiling, the floor, or in any desired direction.

FIG. 2 is similar to FIG. 1, as previously described, but shows the attachment of the receiver coupling of this invention having an angular coupling attached to the vent ducting 1.

In the invention of FIGS. 1-14, the connector coupling 4 and the second connecting member such as a receiver coupling 3 of this invention are releasably attachable to each other by a variety of ways and types of attachment members such as at least one magnet 65, adhesives, clips, a spring, Velcro™ at least one set of Velcro™ type hook and loop fasteners 92a and 92b, textile meshes, and a combination thereof, or with or by other materials known to one skilled in the art for releasably attaching one item to another. When the couplings are attached to one another, exhaust 45 can pass from a dryer exhaust pipe 6, through the flue and aperture of the connector coupling, through the aperture and flue of the receiver coupling to vent ducting. Further, when the apertures of the connector coupling 4 and the receiver coupling 3 are aligned or in substantial alignment, a throughpassage 10 is formed between the couplings.

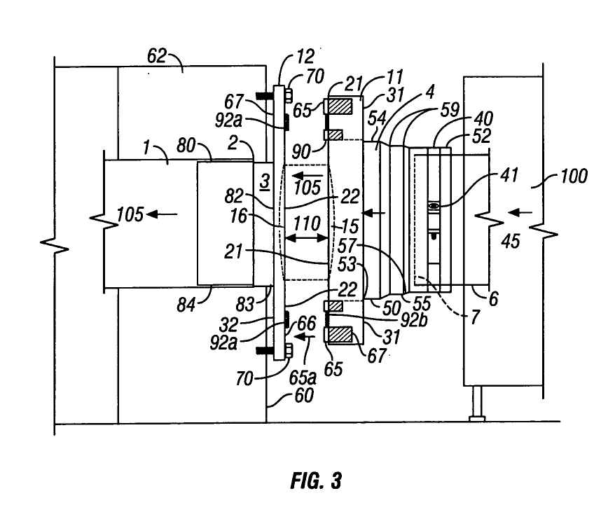

Most typically, a dryer is placed along a wall 60 which has vent ducting 1 within the wall cavity 62 that has an exit 100 to the outdoors as is disclosed in FIG. 1. While the joined couplings, e.g., 3, 4 in the invention in e.g., FIGS. 1, 1a, 3 can provide a substantially straight path 105 for the exhaust substance to travel from the dryer exhaust pipe 6 to vent ducting 1 (See FIG. 3), the invention also provides an angled coupling 8, if necessary to accommodate the connection of a dryer and vent ducting 1, as in FIG. 7, 8, 9.

FIG. 1A shows a dryer 5 with an exhaust pipe 6 that is attached to the first flue 50 of the connector coupling 4. The flue of coupling 4 is flexible, extendable, and collapsible in this embodiment and has ridges 57 in the flue, as well as, folds 59 in the wall of the flue 50. The flue is securably attached to the exhaust pipe 6 of the dryer by using a band 40 that can be adjustably tightened and secured with a screw 41. In this embodiment, the connector plate is positioned adjacent to the dryer. The connector plate 11 has an outer face 31 a portion of which is joined to the outlet side of the flue 50 at connection 53. In this embodiment, a plurality of magnets 65 are positioned within an indentation 67 and protrude beyond the inner face 21 of the plate 11 and are lined up to the inner face 22 of the receiver plate at a portion which has a iron or ferrous portion 66 which is magnetically attractive. To further ensure that the inner faces 21, 22 of the receiver and connector plate do not become detached, in this embodiment there is at least one set of hook and loop fasteners 92a, 92b, respectively positioned on the inner faces of the plates so as to be in substantial alignment when the plates are joined. Additionally, to eliminate or minimize any leakage of the exhaust between the two joined plates, in an embodiment, a gasket 90 is positioned around the apertures. The outlet side 84 of the flue 80 is joined at connection 83 to the outer face 32 of the receiver plate 12. Within this embodiment, the flue 80 of the receiver plate is straight and is inserted into the vent ducting 1 within the cavity 62 of the wall 60. When all these components are connected together, a path for exhaust 105 is present and allows the exhaust to exit to the outdoors 100. Within this embodiment, the receiver plate is anchored to the wall by screws 70. FIG. 2a is substantially the same as the embodiment in the FIG. 1a, however, a flue 80 is inserted into an elbow coupling in the wall that is angular.

Now referring to FIG. 3, a larger cross sectional illustration of an embodiment of FIGS. 1 and 1a of a pair of couplings 3, 4 shown in an aligned, but unjoined position.

FIG. 3 shows a dryer 5 with an exhaust pipe 6 that is attached to the first flue 50 of the connector coupling 4. The flue of coupling 4 is flexible, extendable and collapsible in an embodiment, and has ridges 57 in the flue, as well as, folds 59 in the wall 55 of the flue 50. The flue is securably attached to the exhaust pipe 6 of the dryer by using a band 40 that can be adjustably tightened and secured with a screw 41. Of course, other types of bands and ties known or used by one skilled in the art can be used to secure the flue 50/80 to the exhaust pipe 6 or vent ducting 1. In this embodiment, the connector plate is positioned adjacent to the dryer. The connector plate 11 has an outer face 31 a portion of which is joined to the outlet side of the flue 50 at connection 53. In this embodiment, a plurality of magnets 65 are positioned within an indentation 67 and protrude beyond the inner face of the plate and are aligned with an iron or ferrous portion 66 which is magnetically attractive on the inner face 22 of the connector plate. To further ensure that the inner faces 21, 22 of the receiver and connector plate do not become detached, at least one set of hook and loop fasteners 92a, 92b that is positioned on the inner faces of the plates so as to be in substantial alignment when the plates are joined by the attachment members. Additionally, to eliminate or minimize any leakage of the exhaust between the two joined plates, in an embodiment, a gasket 90 is positioned within about 1½ inch or less around at least one of the apertures 15/16 of the couplings. The inlet side 82 of the flue 80 is joined at connection 83 to the outer face 32 of the receiver plate 12. In this embodiment, the flue 80 of the receiver plate is straight and is inserted into the vent ducting 1 within the cavity 62 of the wall 60. When all these components are connected together, a path for exhaust 105 is present and allows the exhaust to exit to the outdoors 100. In this embodiment, the receiver plate is anchored to the wall by screws 70.

Similarly, the receiver plate 12 of coupling 3 may be secured to wall 60 or is attached, anchored or installed to part of the building structure such as a wall 60 by screws 70, 70, as in FIGS. 1, 1a, 2, 2a, 3, 4, 7, 8, 9, and 10 through anchors, screws, staples, adhesive, hook and loop fasteners such as Velcro™ type fasteners, screws, nails, glue, tape, or a combination thereof, and any other manner or way known to one skilled in the art. Further, the outlet end 84 of the second flue 80 may also be inserted into or around at least a portion of the vent ducting 1 of the structure, permanent, straight, angular, or otherwise.

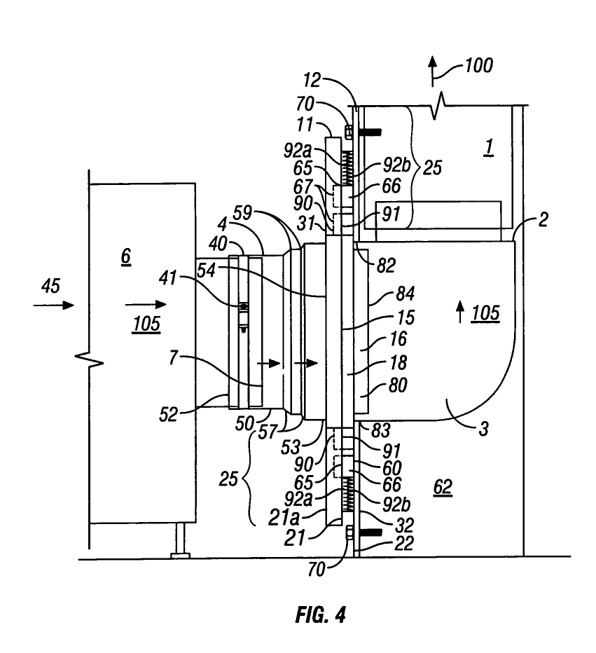

FIG. 4 is substantially the same as the embodiment in the FIG. 3, however, a flue 80 is inserted into an elbow coupling in the wall which is angular, and a portion of the inner faces of the couplings are removably attached to one another. FIG. 4 shows a dryer 5 with an exhaust pipe 6 that is attached to the first flue 50 of the connector coupling 4. The flue 50 of coupling 4 is flexible, extendable, and collapsible in this embodiment has ridges 57 in the flue, as well as, folds 59 in the wall of the flue 50. In this embodiment, the flue is securably attached to the exhaust pipe 6 of the dryer by using a band 40 and adjustable screw 41. In this embodiment, the connector plate is positioned adjacent to the dryer. The connector plate 11 has an outer face 31 a portion of which is joined to the outlet side of the flue 50 at connection 53. In this embodiment, a plurality of magnets 65 are positioned within an indentation 67 and protrude beyond the inner face of the plate and are aligned to the iron or ferrous portion 66 of the inner face 22 of the receiver plate, which is magnetically attractive. To further ensure that the inner faces 21, 22 of the receiver and connector plate do not become detached, in this embodiment there is at least one set of hook and loop fasteners 92a, 92b, positioned on the opposite sides of inner faces 21, 31 of the plates 11, 12 so as to be in substantial alignment when the plates are joined. Additionally, to eliminate or minimize any leakage of the exhaust between the two joined plates, in an embodiment, a gasket 90 is preferably positioned around the aperture of the receiver and/or connector couplings. The inlet side 82 of the flue 80 is joined at connection 83 to the outer face 32 of the receiver plate 12. Within this embodiment, the flue 80 of the receiver plate is straight and is inserted into the angular elbow of the vent ducting 1 within the cavity 62 of the wall 60. When all these components are connected together, a path for exhaust 105 is present and allows the exhaust to exit to the outdoors 100. In this embodiment, the receiver plate is anchored to the wall by screws 70. Of course other anchoring members such as nails, staples, adhesives, hook and loop fasteners, and the like could be used as well.

The coupling having a receiver plate and the coupling having a connector plate can be attached to either the dryer exhaust pipe or the vent ducting in a structure, and in an embodiment the receiver coupling and the connector coupling are interchangeable. However in an embodiment, it may be preferred to join the receiver coupling that has a receiver plate to the vent ducting that exits to the outdoors, and to join the connector plate to the dryer exhaust pipe. In certain circumstances, it may be advantageous to have a fixed receiver plate opposite from the dryer and a connector coupling that has an extendable and collapsible flue that is attached to the dryer for ease of connection. Further once the inner faces of the plate are attached to one another, the dryer can be moved frontward, backwards, or towards the sides.

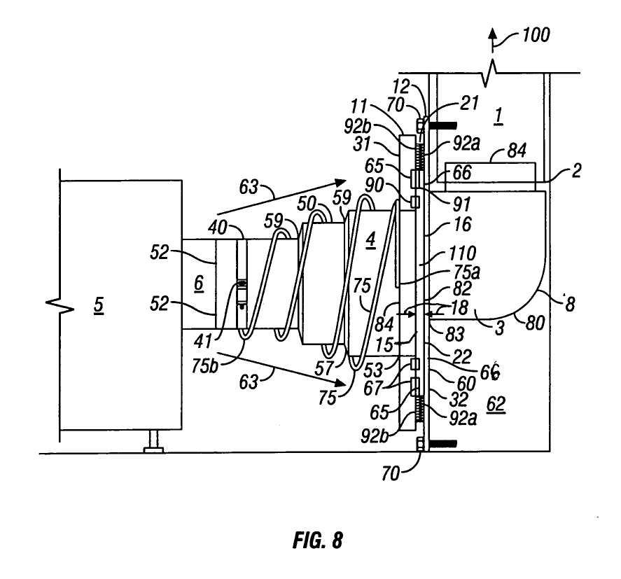

When the inner faces of the receiver and the connector plates are attached, there may still be some distance 18 between the inner faces of the plates themselves 11, 12, which in an embodiment is about 1 inch or less. See e.g. FIG. 8. Of course a greater distance is possible, but may interfere with the sealing capabilities of the plates.

As shown in FIGS. 1, 1A, 2, 2A, 4, and 8 the connector and receiver couplings 3, 4 respectively, are releasably attached by connection members installed into or on the inner faces of the plates 21, 22. The couplings of FIGS. 3, 7, and 9 are in a disconnected state for illustration purposes. The inlet end 52 of the first flue 50 of the connector coupling 4 is sized to matingly connect to a dryer exhaust pipe 6 by fitting or sliding the inlet end onto and over the exhaust pipe 6 of the dryer, and then securing the matingly connected flue so it does not become detached. In FIG. 1a, 2a, 3, 4, 7, 8, 9 an adjustable band 40 with a screw 41 is placed around the pipe 6 and the flue and is tightened and secured by screw 41.

Further, a user may attach the connector coupling 4 to the exhaust pipe 6 of an existing dryer, or the manufacturer may install the connector coupling 4 to the dryer before it is sold. Of course, the order of installation of the connector coupling 4 and the receiver coupling 3 is unimportant. The invention may be installed before or after acquiring the dryer, and receiver coupling 3 may be installed into the building or structure during original construction or during remodeling.

After the connector coupling 4 is attached to the dryer exhaust pipe 6, and the receiver coupling 3 is attached to the vent ducting 1, and the inner faces of the plates of the couplings are aligned, or substantially aligned, by looking at the edges of the plates over the top of the dryer 5c or from the side of the dryer, 5b See e.g., 1a, 2a, then the dryer is pushed back toward the receiver coupling. The dryer is moved towards a wall where the receiver coupling has been anchored. As the inner faces 21, 22 come into proximity of one another, the inner face of the connector plate of the connector coupling and the inner face of the receiver plate of the receiver coupling magnetically attract to each other when said plates are about ½″ to about 2″ apart, thereby causing the magnet of the connector plate to become detachably connected to the inner surface of said receiver plate that has at least a portion of ferrous containing materials 66 thereon that is magnetically attractive. Ideally, the edges of the receiver plate and connector plate are at least substantially aligned before the inner faces become detachably connected. The plates may be comprised of metal that is magnetically attractive, or if the plates are made of materials other than metal, pieces of ferrous containing metal will be positioned opposite of the magnet(s).

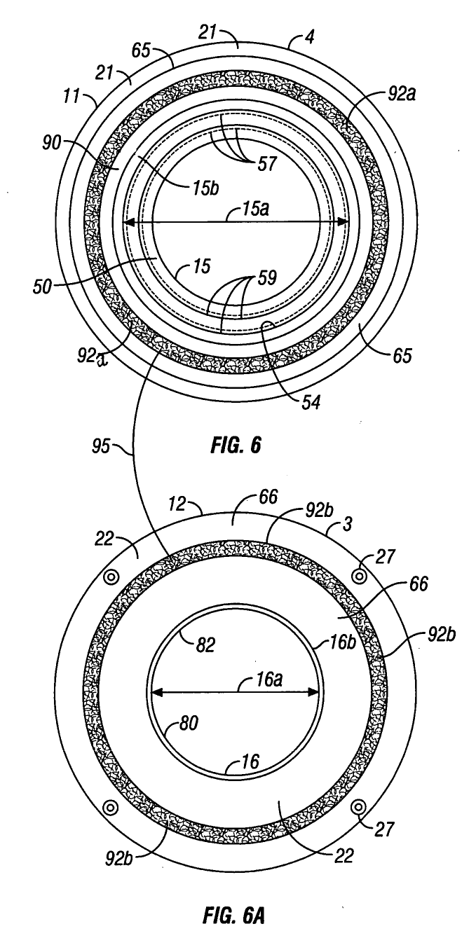

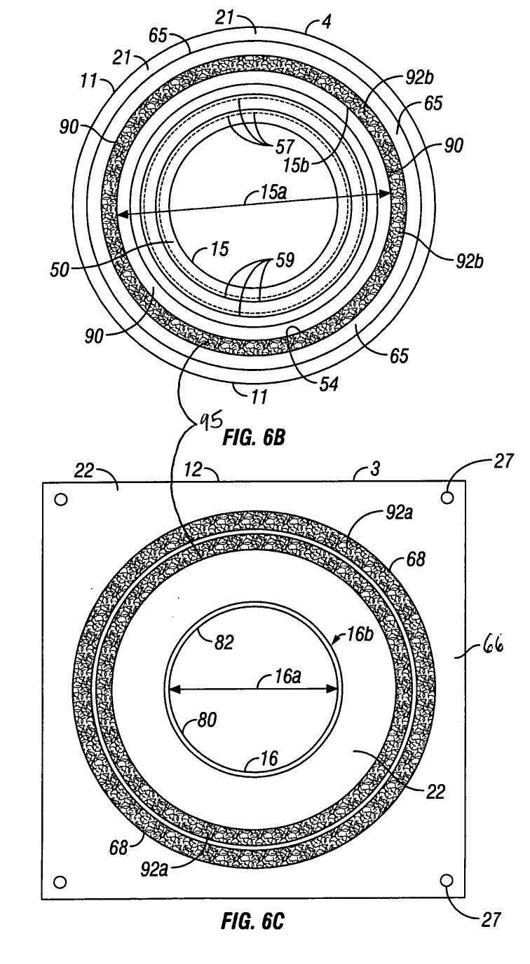

If at least one magnet is placed on the inner face of said receiver plate and at least one magnet is place on the inner face of the connector plate, and the one magnet on the receiver plate is positioned so that it will be adjacent to the magnet on the connector plate, with the poles of the magnets of each plate being of an opposite pole to one another, the magnets will attract to one another when said magnets are at least substantially aligned across from one another. Further, when the magnets come within about 2 inches or less of each other a magnet 68 with an opposing pole that is attractive, as in FIGS. 6b and 6c, the connector plate will move toward the receiver plate and at least a portion of the plates or magnetic connection members will become magnetically attached. Additionally, when magnets are placed on both the receiver and connector plates, the magnets facilitate in the alignment of the plates.

The plates are in substantial alignment when the apertures are in substantial alignment and allow sufficient air flow through the apertures, yet do not permit the escape of the exhaust from misalignment of the plates. In an embodiment the edges of the apertures may be misaligned by about ½ inch to about ¾ inch or less. Of course, the wider the gasket is the more misalignment is possible. Further, in an embodiment, the diameters of the apertures of the receiver and connector plates may be different.

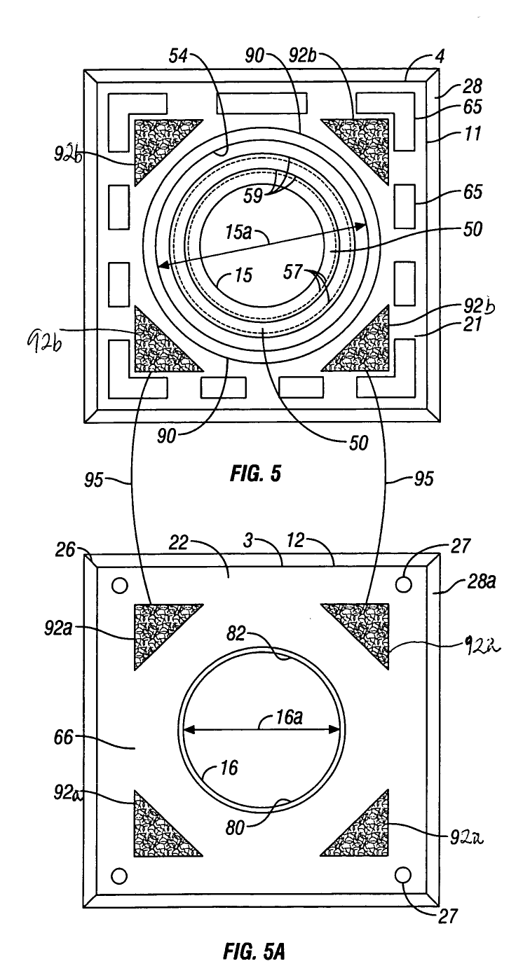

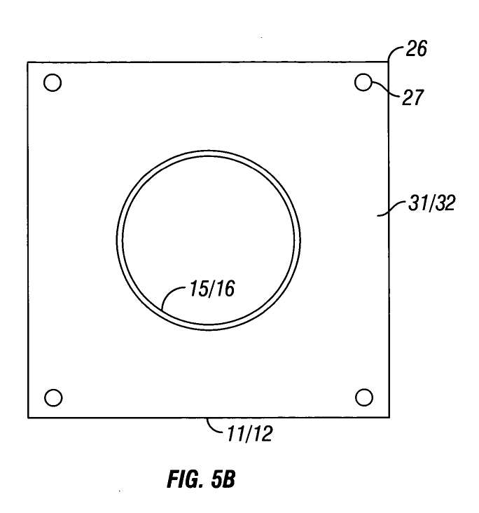

The connector plate 11 and receiver plate 12, of the connector and receiver couplings 4, 3 respectively of FIGS. 1-14 may be of any shape, but are typically circular, as shown in FIG. 6, 6a, or 6b, or quadrangular, i.e., square, or rectangular, as shown in FIGS. 5, 5a, 5b, 6c, 11a, 11b or in any shape or any combination thereof. See FIGS. 6b, 6c. However, any shape will work as long as the apertures 15, 16 are aligned or substantially aligned, and if there is sufficient allowance at the edges 25 of the plates for the inner faces 21, 22 of the plates areas outside of the apertures 15, 16 to facilitate the connecting and sealing members to adjoin and to form a seal 91 to prevent the escape of exhaust from the couplings. See E.g. FIG. 4. Further, the pair of connector and receiver plates 11, 12 are also typically of the same shape, but could also be of differing shapes. See e.g. FIG. 6b, 6c. The connector and receiver plates 11, 12 may be of different sizes, as shown in, e.g., FIG. 4. The plates must be larger in diameter than that of the apertures in order to have sufficient area to place attachment and sealing members on the inner faces of the plates. The plates are preferably at least about 4 inches to about 8 inches in diameter.

The connector and receiver plates, e.g., 11, 12 are usually solid, i.e., except for the aperture and screw mounting holes. The couplings may be a unitary piece with the flues, plates and attachment members being molded into a single piece, or that of a multi-piece design, where the flues are attached to the plates, and the attachment members are installed onto or into the plates. The inner face surfaces 21, 22 of the connector and receiver plates, 11, 12, may also have indentations in certain areas to accommodate magnets 65 or the other attachment members, as well as additional sealing members such as gaskets, e.g., 90 as shown in FIGS. 1a, 2a, 3, 4, 7, 8, 9, 13, and 14. The inner faces 21, 22 of the connector and receiver plates 11, 12 may be planar or alternatively indented near or around the apertures for a variety of reasons such as attachment of the flues, e.g., 50, 80. In an embodiment, one of the plates may also be indented or shaped like a funnel near the apertures (not shown), while the other correspondingly protrudes to facilitate alignment and sealing of the plates 11, 12 and/or apertures 15, 16.

The seal(s) will preferably be located on the inner surfaces of either or both plates 21, 22, near the edges 15b, 16b of the apertures, approximately 2 inches or less from the edges of the apertures. Gaskets may be comprised of a set of hook and loop fasteners 92a, 92b, rubber, felt, magnets, or any other materials known or used in the art for gaskets or sealing. In an embodiment, the gasket is comprised of felt. The gasket can be of various widths, but is preferably about ¼″ to about 1½″.

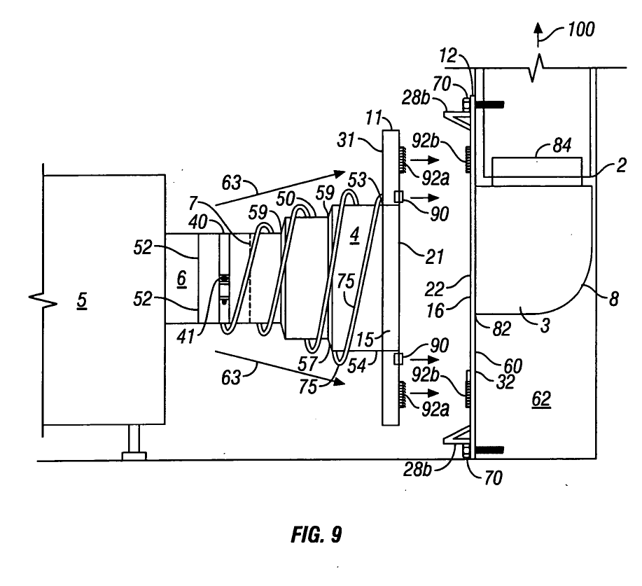

One of the plates 11 or 12 may also have raised edges, alignment tabs, or a flange or frame 28 as in FIG. 5, 5a, 9 that around at least a portion of the perimeter of the edge of the inside face to facilitate alignment of the plates, e.g., 28 as in FIGS. 5, 5a, and 9, but a flange or frame is not necessary.

The connector and receiver plates 11, 12 of the various embodiment of this invention may be constructed of any material common in the art, such as sheet metal, heat resistant plastics and resins, rubber, a combination thereof, and/or other materials known or used in the art. Sheet metal, such as that which is 9 gauge (5/32″) to 12 gauge (7/64″) to 28 gauge (1/64″) in thickness, or greater or less may be used. Ferrous containing sheet metal is preferable.

The connector and receiver plates 11, 12 of this invention may be rigid or semirigid. Typically at least a portion of each connector and receiver plate 11, 12 are steel metal, but could be other types of metal that are magnetically attractive. Also, the plates may be manufactured primarily from nonmetallic component, such as heat resistant plastic, with the receiver plate having metallic portions that are magnetically attractive to magnets on the inner face of the connector plate.

Additionally, other members can be used to releasably attach the couplings 3, 4 or connector and receiver plates 11, 12, such as hook and loop fasteners, Velcro™, adhesives, and combinations thereof, with and without magnets. In the embodiments of the invention shown in FIGS. 1a, 2a, 3-8, at least one of the plates 11, 12 has magnets and/or a magnetic surface 65 or other members that allow for releasable attachment along at least a portion, such as its perimeter, for attachment with the other plate. An embodiment may have only magnets 65 or other such attachment members on only one of the plates 11, 12 which is attracted to and attaches to a ferrous metal portion 66 or posting magnet 68 as in FIGS. 6b and 6c of the adjacent connector and receiver plate 11, 12 of the opposing coupling 4, 3. When the two plates are preferably aligned or in substantial alignment and placed near one another, the magnetic portion 65 of the inner face 21 of one plate, e.g., 11 (or both) will attract 65a and releasably attach to the metallic portion or magnetically attractive portion(s) 66 or opposing magnet 68 of the inner face 22 of the opposing plate, e.g., 12 and form a releasable attachment, which allows for passage of an exhaust substance 45 through coupling 3 and coupling 4 without leaking between the attached connector and receiver plates 11, 12 of coupling 3 and coupling 4. The magnets on the inner surface of one or both plates will magnetically attract to the ferrous metal or opposing magnet as the dryer is moved into place within a certain distance, approximately 2 inches to ½ inch or less. This allows for a hands free releasable connection of the receiver plate and connector plate.

The magnets may be applied to the inner surface of one plate as shown in FIGS. 1a, 2a, 3, 4, 5, 7, 8 or both plates as shown in FIG. 6b and 6c. Additionally, there may be indentations 67, or alternatively, protrusions 13 in certain areas of the inner surfaces of the plates to accommodate magnets 65 or other attachment members, as well as sealing members such as gaskets, e.g., 90 to accommodate various thickness of materials used for the releasable attachment and sealing of the two couplings.

The magnets may be of various shapes. See e.g. FIGS. 5, 6b. The magnets may be in the form of a unitary piece that encircles either or both apertures of the plates. Or, a plurality of magnet pieces may be mounted about the perimeter of either or both of the inner faces. See e.g., FIG. 5. When magnets are used on both plates and aligned across from one another with the magnetic poles configured in position to attract to each other, the magnets allow better alignment of the plates and better holding power than a unitary magnet that attaches to the magnetically attractive metal.

The magnets may be of various thickness and sizes. Typically, the magnets will be at least about ½″ to about 1″ wide and about 1″ to about 3″ long or from 4″ to about 8″ in diameter. The magnets may be of various thickness from about ⅛″ to about ¾″ with ½″ magnets portions and 3/16″ magnet ring being preferable.

Alternatively, or in addition to magnets, a set of fasteners having hook and loop components 92a, 92b, respectively, may be used to releasably attach the inner faces. Velcro™ type hook and loop fasteners are comprised of a first component composed of a multitude of fine hooks 92a, and a second component composed of a multitude of fine loops 92b. By the magnetic attraction and/or the compressed spring pressure pressing on the components that are in alignment or substantial aligned, the hooks are made to enter the loops, which makes it possible to obtain a joined assembly that holds the loops component and hooks component together. The bonding between the two components can be broken by the application of a sufficient separating force. The two components can be assembled and separated several times without a significant decrease in the strength of the assembly.

Alternatively, other attachment means previously disclosed may also be used to detachably connect the couplings, typically at the inner faces of the connector and receiver plates with or without the presence of magnets such as a spring 75 that exerts spring pressure against hook and loop fasteners such as Velcro™ 95 as shown in FIG. 8, 9.

The embodiment of the invention in FIGS. 1-9B has a connector coupling further comprising a first flue 50 defining a first aperture 15 and having a first air inlet end 52 and a first air outlet end 54, with the air inlet end 52 is sized to matingly connect to the exhaust pipe 6 and with the air outlet end being anchored to the connector plate 11 edgewisely, which is to the edge, near the edge, or even into and around the first aperture 15. Similarly, the receiver coupling 3 may comprise a second flue 80 which has a second aperture 16 and a second air inlet end 82 and a second air outlet end 84, with the air inlet end 82 being connected to the receiver plate 12 edgewisely, which is to the edge, near the edge, or even into and around the second aperture 16 and wherein the air outlet end 84 is sized to matingly connect to the vent ducting 1. The first and second flues 50, 80 are typically integral or attached to at least one end or at least a portion of the connector and receiver plates 11, 12. The flues, e.g., 50, 80 may be flush with the connector and receiver plates 11, 12, or may extend into the aperture and/or through the apertures 15, 16.

For all the embodiments, the flues may be secured to the plates in various ways. For example, the flues 50, 80 can be joined to plates 11, 12 by welding or soldering a metal flue to a metal plate, clamping, bridging, netting, riveting the flue to the plate, crimping, crimping with a rolled edge, gluing, molding, casting, and melting, and other such combinations or configurations and manufacture techniques known to one skilled in the art or standard in the industry. One way of joining the plates and the flues is to secure a flue made of metal, plastic, or rubber, is to cast or injection mold one end of the flue directly into a plate made of plastic. Another way of joining a plate to the flue is to crimp the edges of the aperture around one end of the flue, thus attaching the flue to the plate, or to attach the flue to the plate by epoxy or other adhesives.

The flues may be attached to the plates inside the aperture, or the outside edge of the aperture, or around the perimeter of the aperture, most likely within about 1½ inches or less from the edge of the aperture. The connection between the flues and the plates may be made through riveting, welding, crimping, gluing, stamping, molding, casting, or by other ways known by one skilled in the art of connecting metal to metal, metal to plastic, metal to rubber, rubber to plastic, or other material combinations.

The flues 50, 80 may be of any length, but are typically less than about 3 inches to about 6 inches in length, and may be 8 inches or longer, or shorter and less than about two inches in length. The first and second flues 50, 80, respectively are generally tubular in construction, but may be any shape, such as straight, curved, bent, angled. The flues may be of a fixed length, or may be extendable and collapsible to telescope in and out as in FIGS. 1, 1a, 2, 2a, 3, 4, 5, 6, 6b, 7, 8, and 9, as well as, flexible with some horizontal and vertical movement. In an embodiment, the flue of the connector plates is flexible, extendable and collapsible and the flue of the receiver plate is of a fixed length and rigid.

The flues may also be of a constant diameter, or narrowed or widened in places. The flues may also be of a single piece, or formed from multiple pieces. The flues 50, 80 of this invention, see FIGS. 1-14, may be rigid, semirigid, or flexible, extendable and collapsible. The first flue 50 has an end 52 that is sized for mating attachment with the exhaust pipe 6 exiting the unit such as a dryer 5. A common size for a diameter of vent 1 and/or a dryer exhaust pipe 6 is three to five inches, accordingly, an embodiment of the flue 50/80 typically has an annular diameter of approximately three to four inches e.g., as shown in FIG. 5, 6 of FIG. 1-14, 15a, 16a, with the first and second apertures 15, 16 having a diameter of approximately four to five inches, also the connector and receiver plates apertures 15, 16 may differ in diameter with one larger and one smaller to also allow for misalignment between the first and second apertures 15, 16, of the receiver and connector couplings 3, 4, as shown in FIG. 4 of FIG. 1-9 respectively and/or apertures 15, 16 and/or possible misalignment of the inside faces of the connector and receiver plates 11, 12. The first and second flues, e.g., 50, 80 may be made of any material common in the art. Examples may include sheet metal, flexible aluminum tubing, heat resistant or heat tolerant plastic, rubber, resins, polymers and other types of materials, which are known to be heat resistant or tolerant. Typically at least one of the flues, e.g., 50, 80 are flexible and may have rigid portions. A flexible flue or flue portion 50, 80 allow some movement of the unit or dryer after a releasably attached union between the couplings 4, 3 has been made. The connector coupling 4 with flue, e.g., 50 may also be designed so it can be extended in length or pulled outwardly, and can also shorten or contract. This can be accomplished in a variety of ways such as by a series of ridges 57 and folds 59 in an accordion or telescoping-like manner, which enables the flue, e.g., 50 to lengthen and shorten or deviate horizontally and vertically during installation and/or use. The extendable flue may also have an external or integral spring 75 which can be wound to push the flue outwardly for use with or without magnets as in FIG. 8, 9. The allowance of some movement may be advantageous for washer and dryer alignment because many washer and dryer units vibrate during operation and are repositioned from time to time. One manner of securing the connected flue or flues to the dryer exhaust pipe and/or vent ducting, e.g., 50/80 is the utilization of a metal or plastic band 40 around the exhaust or vent pipe and flue. The band 40 may be located near the end 52/82 of the flue 50/80 of coupling 4/3 and tightened by turning or sliding a screw 41 until band 40 grips the exhaust pipe 6 of the unit or vent ducting 1 such that a secure, non-leaking connection is made. However, the invention also contemplates the use of a tie, plastic ties, plastic zip ties, clamps, tension clamps, rope, string, adhesive tape, duct tape, rubber bands, cloth bands and other securing members and devices commonly used and known in the art, to keep a union from becoming disconnected or leakage of exhaust. The securing member such as band 40 must be sufficiently tight to prevent detachment or leaking of exhaust. Alternatively, the connector or receiver coupling 4, 3 respectively may be magnetically or otherwise removably or securably attached directly to the back of the appliance such as a dryer 5 through members such as magnets, a set of hook and loop fasteners such as Velcro™ type fasteners, adhesive, straps, screws, and securing members and devices commonly used and known in the art and a combination thereof.

The inlet end 52 of the first flue 50 may be secured to exhaust pipe 6 by any method that affects or secures connection to the exhaust pipe 6 and the outlet end 84 of the second flue 80 may also be secured to the vent ducting 1 if the outlet end does not already securably and sealably connect to the vent ducting 1. One embodiment in FIGS. 1a, 2a, 3, 4, 7, 8, 9 utilizes a metal band 40 and screw 41.

After installation of the couplings 3, 4, the unit may be placed into service by simply visually aligning the edges of the connector and receiver plates 11, 12 of couplings 3, 4 which will align the first and second apertures 15, 16 and moving the unit toward wall 60 until the magnetic attraction and/or the spring force causes or effects the receiver and connector plates of the couplings 3, 4 to become removably attached by the connection members and a seal 91 is formed between coupling 3 and coupling 4. The gasket 90 allows the exhaust substance 45 to pass through coupling 4, the aligned or substantially aligned apertures 15, 16 forming a throughpassage 110 through coupling 3 and out vent ducting 1. After installation, a user may simply detach the couplings 3, 4 by moving the unit away from wall 60 whenever access is needed between the unit and the wall 60, for example to clean lint out of the couplings, for repair of the dryer, or for reasons unrelated to the dryer and couplings. When use of the dryer is again desired, a user can simply move the dryer back to releasably attach the couplings, requiring only visual alignment of the edges of the connector plate with the receiver plate.

Referring now to FIG. 5, an illustration of an embodiment of the present invention viewed from an inside face 21 of a quadrangular connector plate, 11, which may be utilized in different embodiments of the present invention. In this embodiment, it may be observed that the connector plate 11 is quadrangular with the inner face surface, 21 having magnet portions 65 of any shape (e.g., squares, rectangles, ovals, triangles, or other quadrangular shapes and a combination thereof) located about the connector plate 11. Additionally, gasket 90 is in a ring type design and is placed around the aperture 15, as previously described, and is used to form a seal 91 between the connection of the connector plate 11, and receiver plate 12 such that an exhaust substance may not substantially escape from between the connector plate 11 and receiver plate 12. The releasably attachment is aided with triangular portions of hook and loop fasteners, Velcro™, 92b although any shape would do. The outer edge of connector plate has a flange 28 for alignment with corresponding receiver plate 12 as in FIG. 5a, 9. FIG. 5a shows the inner face 22 of receiver plate 12 of this invention. Where the plate is a receiver plate there will be a plurality of screw mounting holes 27 preferably located near the corner 26 of the quadrangle; i.e., about one inch or less from the edges. An aperture 15, 16 will be located near the center of the plate. The outer edge of the receiver plate has a flange 28a that corresponds with connector plate 11 flange 28 as in FIG. 5. A pair of couplings may only have one edge flanged allowing the other plate edge to center within the flange.

Referring now to FIG. 6, an illustration of an embodiment of the present invention viewed from a face of a circular connector plate, construction of the connector plate 11 may be observed with an aperture 15 with a diameter 15A of approximately 3-5 inches and a flue 50 attached edgewisely of the aperture 15. Connector plate 11 may be constructed by any manner common in the art. Additionally, a magnetic portion 65 may be located on the inner face 21 of connector plate 11. As shown in FIG. 6, magnetic portion 65 may be continuous circular unitary magnet located at or about the perimeter of the plate. Further, the attachment members may not be a magnet or magnets at all and may be constructed of another substance capable of releaseable attachment or engagement with another portion such as at least one magnet, adhesives, magnets, hook and loop fasteners such as Velcro™ type fasteners, a spring with outward spring pressure, and/or a combination thereof, or with or by other materials known to one skilled in the art that are capable of forming a releasable connection between two separate parts, e.g., as in FIGS. 7-8.

Additionally, a gasket 90 may be placed on the inside face, e.g., 21 of connector plate 11 to aid in sealing and releasable attachment of a pair of plates to prevent exhaust from escaping out the throughpassage 110 (See, e.g., FIGS. 3, 4) formed when the apertures of the connector and receiver plates 11, 12 of FIGS. 6 and 6a are connected. Any material may be used as a gasket 90, for example, felt, plastic and adhesive, rubber, and others that effectuate a seal 91 with connector and receiver plate 11, 12 and another portion and the magnets and/or a set of hook and loop fasteners 92 such as Velcro™ may also be used as gaskets 90 FIG. 6 and FIG. 6a also has a circular ring of hooks and loop fasteners 92a and 92b as part of the connecting members of plates 11, 12 of couplings 4, 3.

Any number of screws 70 may be used to secure receiver plate, e.g., 12, and typically a plurality of holes 27, 27, as shown in FIG. 6a, which may also be sunken, recessed, and/or beveled are defined on the receiver plate 12 to recess the screw 70 or other attachment means so that the head of the screw is flush with the plate. However, the invention contemplates use of any anchors common in the art such as bolts or adhesives, glue, hook and loop, staple nails or other suitable means for anchoring the plate to a structure or building.

FIG. 5a shows a quadrangular receiver plate 12 whose inner face 22 has a plurality of sets of hook and loop 92a type fasteners, here in this embodiment in triangular shapes distributed around and near the perimeter of the gasket and aperture. Of course, the positioning of the hook and/or loop fasteners is unimportant as long as they are substantially aligned with their counterpart on the connector plate, and provide sufficient holding power. The hook and loop fasteners can be of any shape, including but not limited to, rectangular, square, circular, and the like. In this embodiment, the receiver plate 12 is made of a magnetically attractive material 66. In this embodiment, there are also preferably a plurality of holes such as screw mounting holes 27 into which anchoring members can be inserted and then secured to the structure of the building. In this embodiment, there is one hole 27 located near each corner 26 of the plate. The inlet end 82 of the flue 80 is connected in this embodiment within the aperture 16 of the plate. The diameter 16a of the aperture is preferably the same size as the exhaust pipe 6 of the dryer and/or the vent ducting 1 that is installed within the structure. FIG. 5 shows a connector plate 11 whose inside face 21 has a plurality of magnets 65 distributed around the perimeter of the plate and has corresponding loop 92b fasteners that are in a mirror image type fashion 95. The connector plate of FIG. 5 further has a gasket 90 around the perimeter of the aperture 15. The diameter 5a of the aperture is preferably about the same size or larger than the aperture of the adjacent plate and of the exhaust pipe and/or vent ducting 1 in a wall. There is a flue 50 that extends outwardly from the connector plate and has a plurality of ridges 57 and folds 59. While not required, the plates of the couplings of this invention may have alignment tabs or alignment frame 28 and 28a around the perimeter of the plate in order to assist in the alignment of the connector 11 and receiver plate 12. FIGS. 6a, and 6 are substantially similar to the inner surfaces 22, 21 of the receiver 12 and connector 11 plate of FIGS. 5a, and 5. The primary difference between these plates and the plates of FIGS. 5, and 5a is the shape of the connector and receiver plates. FIG. 6a also has a plurality of screw mounting holes 27, preferably for, positioned around the perimeter of the plate. The plate of FIG. 6a has a circular piece of loop fasteners 92b which are in substantial mirror image type alignment 95 with the hook fasteners 92a of FIG. 6. On the inner surface of the receiver plate, the gasket 90, hook fasteners 92a, and magnet are all ring shaped and are positioned to one another in a concentric fashion with the magnet being outermost, the gasket being innermost, and the hook fasteners being between the gasket and the magnet . Of course the position of the magnet and the hook fasteners, may be reversed as long as their counterpart are also similarly placed on the receiver plate. The magnet 65 is placed so that it will be in a position to magnetically attract to the ferrous type metal 66 of the receiver plate 12. FIGS. 6b and 6c show a quadrangular receiver plate 12 that is paired with a circular connector plate 11. Also the connector plate 11 and receiver plate 12 shows a circular magnetic ring on both plates 65, 68 positioned in a mirror image type alignment 95 with the magnetic poles configured to attract one magnet toward the other. This will also aid in the alignment of the plates and increase the attraction and holding power than a single magnet magnetically attracting to a ferrous metal portion or plates.

Referring now to FIG. 7, an illustration of embodiments of the present invention with a rigid or semi-rigid coupling, e.g., 3 in an angular attachment arrangement with an elbow 8 within the couplings 3, it may be observed that in wall and out of wall connections are contemplated within the spirit of the present invention. The first flues 50 of the embodiments in FIGS. 1a, 2a, 3, 4, 7, 8, 9 are flexible and horizontally extended or telescoped outwardly from the outside face, e.g., 31 of the connector plate 11. In FIG. 3, 7, 9 the two couplings 3, 4 are shown in an aligned and unjoined position. The second flue 80 of the receiver plate 3 shown installed out of a wall 60 using spacers 130 and longer screws 70 that fit into and through the spacers 130. Spacers 130 may include ferrules (shown), brackets, blocks, flanges, straps, or any other combination thereof or other such spacing members known to one skilled in the art and may be of a number of materials such as metals, plastic, etc. The flexible flue 50 again may have ridges 57 and folds 59. Again, the inlet end 52 of the first flue 50 is sized for mating connection with the exhaust pipe 6 and has a band 40 and screw 41 tightened around the connection to prevent flue 50 from becoming detached from the exhaust pipe 6. Also as shown in FIG. 8, 9 the flue 50 may also have a spring 75 which is external or integral (within the flue wall 55), which may be wound to push the flue outwardly from the plate, 11, and may assist in releasable attachment of the coupling as shown in FIGS. 8 and 9. As will be seen by those skilled in the art, the couplings may be generally the same distance from a floor or lower surface to be appropriately attached as in FIGS. 1-4, 7, 8, and 9. The embodiment in FIG. 7 contemplates use out of the wall 60 when the vent pipe 1 is displaced horizontally or vertically or combination thereof and the user or installer intends not to redesign the present existing vent configuration. The installer may connect piping from the outlet end 84 of coupling 3 with angled flue 8 using standard materials, such as solid piping, flexible ducting, elbows, or other materials known to one skilled in the art, to complete the connection to existing wall vent 1. Flexible ducting 120 is shown in FIG. 7 to illustrate this configuration with the present invention. This type of configuration allows the proper placement of the receiver plate 11 of coupling 3, while retaining the benefits of releasable attachment without the need of moving an existing in wall vent system for venting dryer exhaust to the exterior of a building. Referring now to angular receiver coupling 8 and flues of FIGS. 7, 8, 9, 11a, 11b, 11d, the flue of the coupling 3 is angled. The angled flue would typically be rigid or semirigid, and the coupling may further be rotatable near or at the inlet and/or outlet end of the flue, e.g., 82, 84, respectively. Also, as in FIG. 1-14, the inner surface of the connector and receiver plate may have a hook and loop fastener 92a, and 92b lining, which corresponds to one another.

FIG. 8 is a side view of an embodiment of this invention where there is a dryer 5 exhaust pipe 6 that has the inlet 52 of the flue 50 of the connector plate 11 securably attached to it by a band 40 and a screw 41 and screw clamp 41, 42. The flue 50 is pushed outwardly from the connector plate by a spring 75 which exerts force 63 to hold the connector plate 11 away from the inlet end 52 of the flue. The spring is attached at one end 75a to or about the connector plate, and the other end 75b by or about the band 40. In this embodiment, there are a plurality of magnets 65 and a gasket 90 positioned within recesses 67 as well as loop fastener counterparts 92b on the inner surface 21 of the connector plate 11. The apertures 15, 16 of the connector and receiver plates 11, 12 are in substantial alignment and form a throughpassage 110. In this embodiment, the flue 80 of the receiver coupling is installed within the wall cavity 62 and is connected at the outlet end 84 to the vent ducting 1. The receiver plate 12 is anchored to the wall 60 by screws 70. In a mirror image type fashion, hook fasteners 92a are positioned opposite the loop fasteners 92b of the connector plate. The inner surface 22 of the receiver plate 12 has magnetically attractive metal 66 positioned opposite the magnets 65 of the connector plate.

FIG. 9 is an embodiment of the couplings 3, 4 in a aligned but unjoined position. This embodiment is similar to that previously described for FIG. 8 except that only hook and loop members 92a, 92b are used to removably attach the inner faces 22, 21 of the receiver and connector plates 12, 11.

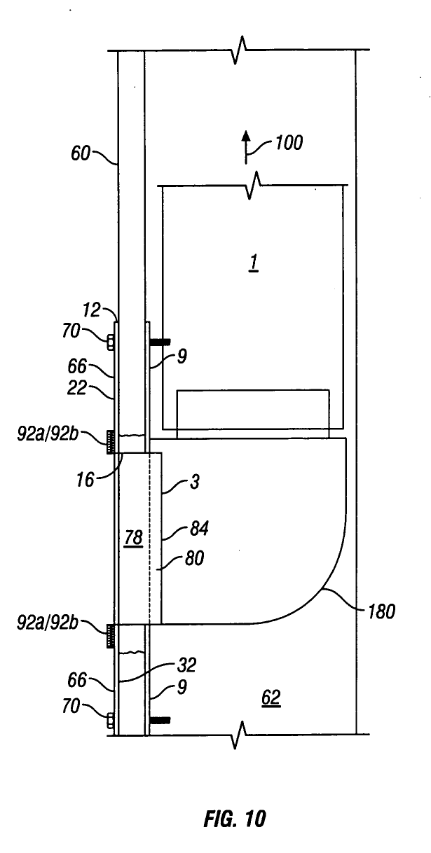

FIG. 10 shows a side view of a receiver plate 12 anchored to a wall 60 with screws 70. The flue 80 is shown inserted into an angular coupling in the vent ducting 1.

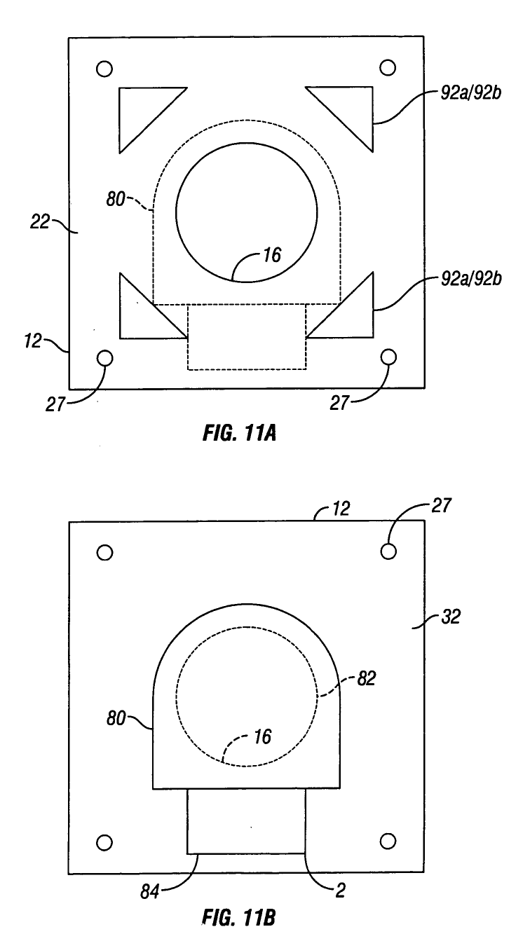

FIG. 11a is an illustration of the front view of the inner face 22 of a receiver coupling 12 with an angular flue 80. Pieces of the hook components 92a and/or loop components 92b are shown on the inner face. Further a plurality of holes 27 are near the corners of the plate for anchoring the receiver plate to a structure or building.

FIG. 11b is an illustration of the back view of the outer face 32 of the receiver plate 12 of the invention with an angular flue 80 having an inlet end 82 and an outlet end 84

FIG. 11c is a further illustration of a view of outlet 84 of an angular or angled flue 80 in a receiver plate 12 of a receiver coupling 3 of the present invention that has an aperture 16. There is at least one hole 27 on the plate for anchoring the receiver plate to a structure or building. Pieces of the hook components 92a and/or loop components 92b are shown on the inner face.

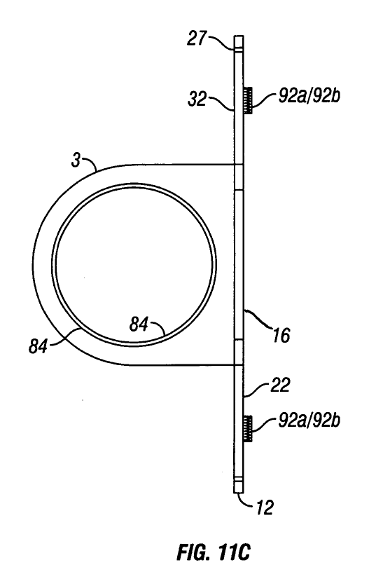

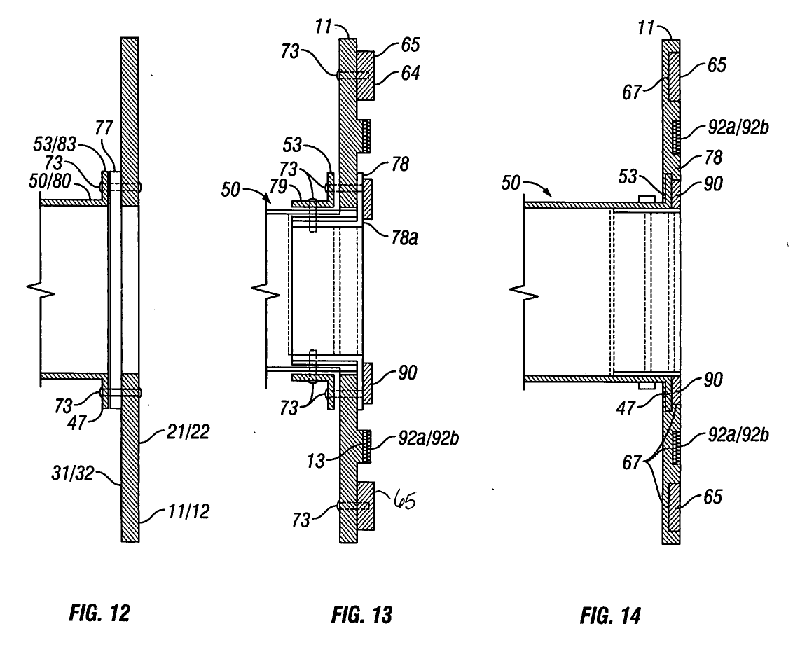

FIG. 12 is a cross-sectional side view showing an embodiment of this invention and one of the ways the flue can be joined to the receiver or connector plate 12, 11. The flue 80/50 may have a sideways deviation or rim flange 47 and have adhesive 77 sandwiched between the deviated portion of the flue and the outer surface 32/31 of the receiver 12 or connector plate 11, respectively. Further, the flue may be anchored to the plate by a rivet 73.

FIG. 13 shows a connector plate 11. It has a flue 50 anchored to it by a sleeve assembly comprised of an inner sleeve 78 and an outer sleeve 79. The sleeves are attached to the flue and plate by rivets 73, but may also be attached by adhesives with or without riveting. The gasket 90 is attached to the front facing 78a portion of the inner sleeve 78. Hook and loop fasteners 92a or (92b) are installed on a protrusion 13 of the plate. A magnet 65 is shown attached to the plate by a rivet 73.

FIG. 14 shows a cross-sectional side view of a further alternative way of attaching the flue 50 to a connector plate 11. The flue again has a deviated portion 47 at least partially perpendicular to the body of the flue. The inner surface of the plate features a magnet 65 and/or hook and loop fasteners 92a or (92b) and/or gasket 90 in recesses 67. In FIG. 14 the connector plate is partially comprised of a non metallic material and the flue is connected to the plate by injection molding, but could also be cast.

Furthermore, this invention comprises an apparatus for connecting a clothes dryer exhaust pipe 6 to vent ducting 1 that exits to the outdoors 100, comprising a connector coupling 4 comprising a connector plate 11 having an inner face 21 and an outer face 31, with a first aperture 15 that extends through the inner and outer face of the plate, a receiver coupling 3 comprising a receiver plate 12 having an inner face 22 and an outer face 32, with a second aperture 16 that extends through the inner and outer face of the plate, wherein at least a portion of the inner face of the receiver plate is magnetically attractive metal 66. Further, there is at least one magnet 65 on the inner face of the connector plate 11, and at least one magnet 65 is positioned so that it will be adjacent to the magnetically attractive metal 66 on the receiver plate 12 when the receiver plate and connector plates are at least substantially aligned across from one another, wherein the inner faces of the couplings are capable of detachable connection to each other by at least one magnet 65. Also, there may be at least one gasket 90 placed between the inner face of the connector plate and the inner face of the receiver plates to prevent dryer exhaust 45 from escaping from between the couplings when they are detachably connected and when the dryer is in use. In addition there may be at least one set of fasteners 92 comprising hook components 92a and loop components 92b, wherein the hook components are attached to the inner face of the receiver plate and the loop components are attached to the inner face of the connector plate, or wherein the hook components are attached to the inner face of the connector plate and the loop components are attached to the inner face of the receiver plate, and wherein the hook and loop components form a holding assembly when the hook and loop components are joined together. The hook and loop fastener components assist in holding the inner faces of the couplings together.

Additionally, the connector coupling 4 member may further comprise a first flue having an air inlet end 52 and an air outlet end 54, wherein the air outlet end of the flue is connected to the connector plate 11, around or within the first aperture 15. The flue of the connector coupling may be telescopingly extendable and collapsible.

Also, during use the inlet end of the first flue 50 of the connector coupling is connected to a dryer exhaust pipe 6. A band may be secured around the connection between the flue and the exhaust pipe to prevent detachment of the flue.

The receiver coupling 3 member also further comprises a second flue 80 having an air inlet end 82 and an air outlet end 84, wherein the air inlet end is connected to the receiver plate 12, around or within the second aperture 16. In an embodiment, the flue of the receiver coupling is rigid and/or has a fixed length.

During use, the air outlet end of the second flue of the receiver coupling is connected to vent ducting 1 that exits to the outdoors 100.

The inner face 21 of the connector plate 11 of the connector coupling 4 and the inner face 22 of the receiver plate 12 of the receiver coupling 3 magnetically attracts to each other when the plates are about ½″ to about 2″ apart, thereby causing the magnet of the connector plate to become detachably connected to the inner surface of the receiver plate. A throughpassage is formed when the aperture of the receiver plate and the aperture of the connector plate are at least substantially aligned and allow the flow of air through the couplings.

The edges of the receiver plate and connector plate as well as the apertures of both plates are at least substantially aligned before the inner faces become detachably connected.

Additionally, there may also be at least one magnet 68 on the inner face 22 of the receiver plate 12, wherein the at least one magnet 68 on the receiver plate is positioned so that it will be adjacent to the at least one magnet 65 on the connector plate 11 with the poles of the at least one magnet on the receiver plate and connector plate being of opposite poles to one another so the magnets will attract to one another when the magnets are at least substantially aligned across from one another. Further, placement of magnets 68, 65 on both the receiver and connector plates 12, 11 facilitate in the alignment of the plates. Also, the placement of a magnet on both of the inner faces of the receiver and connector plates provides better holding force than the placement of a magnet on the inner surface of only one of the plates.

A ring shaped magnet or a plurality of magnets are placed around the aperture of the connector plate and/or receiver plate.

The gasket 90 may be comprised of at least one magnet and/or fasteners comprised of hook components and loop components. Alternatively, the gasket may be comprised of materials other than magnets or fasteners comprised of hook components and loop components.

The inner face of the receiver plate and the inner face of the connector plate are separated by a space of less than about 1 inch when the plates are joined by the magnet and/or hook and loop type fasteners.

The apparatus may have at least one indentation 67 in the inner face of the connector plate 11 and/or the receiver plate 12, wherein at least a portion of the gasket 90 is position within the indentation. Also, there may be at least one indentation 67 in the inner face of the connector plate 11 and/or the receiver plate 12, wherein at least a portion at least one magnet is positioned within the indentation. Further, there may be at least one indentation 67 in the inner face of the connector plate and/or the receiver plate, wherein at least a portion of the hook fastener components 92a, 92b and/or the loop fastener components positioned within the indentation 67.

In an embodiment, the connector plate and/or the receiver plates are primarily comprised of ferrous containing metal. In another embodiment, the connector plate and/or the receiver plate is primarily comprised of nonmetallic material, with the inner face of each plate having a magnetically attractive portion.

The apparatus may have a spring 75 that is integral with or on the outside of the extendable and collapsible flue 50 that pushes the inlet end 52 of the flue away from the outlet end 54 of the flue 50.

A method of connecting a dryer exhaust pipe to vent ducting, is also contemplated using this invention. Again the apertures of the plates should be at least substantially aligned and opposite to one another and the dryer unit with the attached connector plate is pushed toward the inner face of the connected receiver plate until the inner face of the connector plate becomes detachably connected to the inner face of the receiver plate. Then, once the coupling have been connected, the dryer may be turned on, allowing exhaust to flow from the dryer, through the connector couplings and to the vent ducting.

In an alternative embodiment, the apparatus for connecting a clothes dryer exhaust pipe to vent ducting that exits to the outdoors, comprises a connector coupling 4 comprising a connector plate 11 having an inner face 21 and an outer face 31, with a first aperture 15 that extends through the inner and outer faces of the connector plate, and a receiver coupling 3 comprising a receiver plate 12 having an inner face 22 and an outer face 32, with a second aperture 16 that extends through the inner and outer faces of the receiver plate.

The connector coupling 4 member further comprises a first flue 50 having an air inlet end 52 and an air outlet end 54, wherein the air outlet end is connected to the connector plate 11, around or within the first aperture 15, and wherein the receiver coupling 3 member further comprises a second flue 80 having an air inlet end 82 and an air outlet end 84, wherein the air inlet end is connected to the receiver plate 12, around or within the second aperture 16. The air outlet end of the second flue of the receiver coupling is connected to vent ducting 1 that exits to the outdoors 100 and the air inlet end 52 of the first flue 50 of the connector coupling 4 is connected to a dryer exhaust pipe 6.

Further, there may be at least one gasket 90 placed between the inner face of the connector plate and the inner face of the receiver plate to prevent dryer exhaust from escaping from between the inner faces of the couplings when they are detachably connected and when the dryer is in use. Also, at least one set of fasteners 92 comprising hook components 92a, 92b and loop components are attached to the inner face of the receiver plate and the loop components are attached to the inner face of the connector plate, or the hook components are attached to the inner face of the connector plate and the loop components are attached to the inner face of the receiver plate, wherein the hook components and the loop components are substantially aligned across from one another. The inner faces of the couplings are capable of detachable connection to each other by fasteners having a hooks component and a loops component, and wherein the hook and loop components form a holding assembly when the hook and loop components are joined together.

Also, a spring 75 may be placed within or on the outside of the extendable and collapsible flue, and wherein the spring pushes the inlet end of the flue away from the outlet end of the flue, and contacts the inner surface of the receiver plate when the dryer is pushed toward the receiver plate.

A method of coupling a dryer exhaust pipe 6 to vent ducting 1 is also contemplated by the present invention generally comprising the steps:
attaching a connector coupling member comprising a flexible, extendable and collapsible flue with a connector plate having an inner face and defining a first aperture to a dryer exhaust pipe;
attaching a receiver coupling member comprising a rigid or semi rigid flue with a receiver plate having an inner face and defining a second aperture to vent ducting;
moving the dryer backward toward the wall and receiver coupling member while
visually aligning or substantially aligning edges of the connector and receiver plates of the connector and receiver coupling members so the first and second apertures form a throughpassage; and
without other manual assistance releasably attaching the connector and receiver coupling members.

This method may also further comprise:
causing a magnetic attraction and engagement between at least a portion of the connector and second inner faces, also causing an engagement of the hook and loop fasteners, with or without spring force pressure and allowing the flow of air therethrough.

In this method, the connector coupling member may further comprise a first flue defining a first aperture and having open air inlet and outlet ends, the air inlet end sized for mating with the dryer exhaust pipe and the air outlet end sized for mating with the aperture and fixedly, edgewisely attached to the connector plate.

Also in this method, the receiver coupling member may further comprise a second flue defining a second aperture and having open air inlet and outlet ends, with the air inlet end sized for mating with the second aperture and fixedly, edgewisely attached to the receiver plate and the air outlet end sized for mating with the vent ducting.

The method may also further comprise:
turning the dryer on and allowing exhaust to flow from the dryer, through the connector coupling member, the throughpassage, and through the receiver coupling member, and to the vent ducting.

It is noted that the embodiment of apparatus described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. An apparatus for connecting a clothes dryer exhaust pipe to vent ducting that exits to the outdoors, comprising:
a connector coupling comprising a connector plate having an inner face and an outer face, with a first aperture that extends through the inner and outer faces of said plates;
a receiver coupling comprising a receiver plate having an inner face and an outer face, with a second aperture that extends through the inner and outer faces of said plates, wherein at least a portion of the inner face of said receiver plate is magnetically attractive metal;
at least one magnet on the inner face of said connector plate, wherein said at least one magnet is positioned so that it will be adjacent to said magnetically attractive metal on said receiver plate when the receiver plate and connector plates are at least substantially aligned across from one another, wherein the inner faces of said couplings are capable of detachable connection to each other by at least one said magnet;
at least one gasket placed between the inner face of said connector plate and the inner face of said receiver plates to prevent dryer exhaust from escaping from between said couplings when they are detachably connected and when said dryer is in use;
at least one set of fasteners comprising hook components and loop components, wherein the hook components are attached to the inner face of the receiver plate and the loop components are attached to the inner face of the connector plate, or wherein the hook components are attached to the inner face of the connector plate and the loop components are attached to the inner face of the receiver plate; and
wherein the hook and loop components form a holding assembly when said hook and loop components are joined together.

2. The apparatus of claim 1, wherein said connector coupling member further comprises a first flue having an air inlet end and an air outlet end, wherein said air outlet end of said flue is connected to the connector plate, around or within said first aperture.

3. The apparatus of claim 2, wherein said air inlet end of said first flue of said connector coupling is connected to a dryer exhaust pipe.

4. The apparatus of claim 1, wherein said receiver coupling member further comprises a second flue having an air inlet end and an air outlet end, wherein said air inlet end is connected to the receiver plate, around or within said second aperture.

5. The apparatus of claim 4, wherein said air outlet end of said second flue of said receiver coupling is connected to vent ducting that exits to the outdoors.

6. The apparatus of claim 1, wherein the inner face of the connector plate of the connector coupling and the inner face of the receiver plate of the receiver coupling magnetically attracts to each other when said plates are about ½″ to about 2″ apart, thereby causing the magnet of the connector plate to become detachably connected to the inner surface of said receiver plate.

7. The apparatus of claim 1, wherein the edges of the receiver plate and connector plate are at least substantially aligned before the inner faces become detachably connected.

8. The apparatus of claim 1, further comprising at least one magnet on the inner face of said receiver plate, wherein said at least one magnet on said receiver plate is positioned so that it will be adjacent to said at least one magnet on the connector plate with the poles of said at least one magnet on the receiver plate and connector plate being of opposite poles to one another so the magnets will attract to one another when said magnets are at least substantially aligned across from one another.

9. The apparatus of claim 8, wherein the placement of magnets on both the receiver and connector plates facilitate in the alignment of the plates.

10. The apparatus of claim 9, wherein the placement of a magnet on both of the inner faces of the receiver and connector plates provides better holding force than the placement of a magnet on the inner surface of only one of said plates.

11. The apparatus of claim 1, wherein said gasket is comprised of at least one magnet and/or fasteners comprised of hook components and loop components.

12. The apparatus of claim 1, wherein said gasket is comprised of materials other than magnets or fasteners comprised of hook components and loop components.

13. The apparatus of claim 1, wherein said hook and loop fastener components assist in holding the couplings together.

14. The apparatus of claim 1, wherein a throughpassage is formed when the aperture of the receiver plate and the aperture of the connector plate are at least substantially aligned and joined to allow the flow of air through said couplings.

15. The apparatus of claim 1, the inner face of the receiver plate and the inner face of the connector plate are separated by a space of less than about 1 inch when the plates are joined by the said at least one magnet.

16. The apparatus of claim 1, having at least one indentation in the inner face of the connector plate and/or the receiver plate, wherein at least a portion of said gasket is position within said indentation.

17. The apparatus of claim 8, having at least one indentation in the inner face of the connector plate and/or the receiver plate, wherein at least a portion of at least one of said at least one said magnet is positioned within said indentation.

18. The apparatus of claim 1, having at least one indentation in the inner face of the connector plate and/or the receiver plate, wherein at least a portion of the hook fastener components and/or the loop fastener components positioned within said indentation.

19. The apparatus of claim 1, wherein said connector plate and/or said receiver plates are primarily comprised of ferrous containing metal.

20. The apparatus of claim 1, wherein said connector plate and/or said receiver plate is primarily comprised of nonmetallic material, with the inner face of each plate having a magnetically attractive portion.

21. The apparatus of claim 2, wherein the flue of the connector coupling is extendable and collapsible.

22. The apparatus of claim 21, having a spring integral with or on the outside of said extendable and collapsible flue that pushes said inlet end of said flue away from said outlet end of said flue.

23. The apparatus of claim 4, wherein the flue of the receiver coupling is rigid and/or has a fixed length.

24. The apparatus of claim 1, having a ring shaped magnet or a plurality of magnets placed around the aperture of said connector plate.

25. The apparatus of claim 3, wherein a band is secured around said connection between said flue and said exhaust pipe to prevent detachment of said flue.

26. A method of connecting a dryer exhaust pipe to vent ducting, using the apparatus of claim 1.

27. The method of claim 26, further comprising the steps of:
adding a first flue to said connector coupling, wherein said first flue has an air inlet end and an air outlet end, wherein said air outlet end is anchored to the connector plate, around or within said first aperture; and
adding a second flue to said connector coupling, wherein said second flue has an air inlet end and an air outlet end, wherein said air inlet end is anchored to the receiver plate, around or within said second aperture.

28. The method of claim 27, further comprising the step of placing a spring within or on the outside of said extendable and collapsible flue that pushes said inlet end of said flue away from said outlet end of said flue.

29. The method of claim 27, further comprising the steps of:
connecting the air inlet end of said first flue of said connector coupling to a dryer exhaust pipe; and
connecting the air outlet end of said second flue of said receiver coupling to vent ducting that exits to the outdoors.

30. The method of claim 29, further comprising the steps of:
at least substantially aligning the apertures of the connector and receiver coupling members opposite to one another; and
pushing the dryer unit with the attached connector plate toward the inner face of the connected receiver plate until the inner face of the connector plate becomes detachably connected to the inner face of the receiver plate.

31. The method of claim 30, further comprising the step of:
turning the dryer on and allowing exhaust to flow from said dryer, through said connector couplings and to said vent ducting.

32. An apparatus for connecting a clothes dryer exhaust pipe to vent ducting that exits to the outdoors, comprising:
a connector coupling comprising a connector plate having an inner face and an outer face, with a first aperture that extends through the inner and outer faces of said connector plate;
a receiver coupling comprising a receiver plate having an inner face and an outer face, with a second aperture that extends through the inner and outer faces of said receiver plate;
at least one gasket placed between the inner face of said connector plate and the inner face of said receiver plate to prevent dryer exhaust from escaping from between said inner faces of said couplings when they are detachably connected and when said dryer is in use; and
at least one set of fasteners comprising hook components and loop components, wherein the hook components are attached to the inner face of the receiver plate and the loop components are attached to the inner face of the connector plate, or wherein the hook components are attached to the inner face of the connector plate and the loop components are attached to the inner face of the receiver plate, wherein said hook components and said loop components are substantially aligned across from one another; and
wherein the inner faces of said couplings are capable of detachable connection to each other by fasteners having a hooks component and a loops component, and wherein the hook and loop components form a holding assembly when said hook and loop components are joined together.

33. The apparatus of claim 32, wherein said connector coupling member further comprises a first flue having an air inlet end and an air outlet end, wherein said air outlet end is connected to the connector plate, around or within said first aperture, and wherein said receiver coupling member further comprises a second flue having an air inlet end and an air outlet end, wherein said air inlet end is connected to the receiver plate, around or within said second aperture.

34. The apparatus of claim 33, wherein said air outlet end of said second flue of said receiver coupling is connected to vent ducting that exits to the outdoors and wherein said air inlet end of said first flue of said connector coupling is connected to a dryer exhaust pipe.

35. The apparatus of claim 34, where a spring is placed within or on the outside of said extendable and collapsible flue, and wherein said spring pushes said inlet end of said flue away from said outlet end of said flue.
